(19) United States
(12) Patent Application Publication
(10) Pub. No.: US 2003/0145069 A1
(43) Pub. Date: Jul. 31, 2003

(54) Virtual network configuration verification

(76) Inventors: Richard C. Lau, Morganville, NJ (US); Frank C. D. Tsai, Morganville, NJ (US); Arturo Cisneros, Lincroft, NJ (US); Krishna Kant, Shrewsbury, NJ (US); Bruce S. Siegell, Shrewsbury, NJ (US)

Correspondence Address: David M. Rosenblatt, Esq., Telcordia Technologies, Inc., 445 South Street 1G112R, Morristown, NJ, 07960, US

(21) Appl. No.: 10/062,909

(22) Filed: Jan. 31, 2002

(51) Int. Cl. G06F 15/177

(52) U.S. Cl. 709/220; 709/224

(57) ABSTRACT

Methods, apparatus, and systems are provided to verify a configuration of a network. A first set of information relating to a virtual representation of the network and a second set of information relating to the state of the network are provided. The first and second sets of information may include information, such as information about provisioning of the network and management information base parameters, respectively. Based on the first set and second set of information, it is determined whether the virtual representation and the state of the network are consistent with each other.

### CROSS REFERENCE TO RELATED APPLICATIONS

This application is related to U.S. application Ser. No. ______, entitled “Auto-Discovery of Network Configuration,” filed concurrently with the present application.

### FIELD OF THE INVENTION

The present invention relates to communication networks and, in particular, to methods, apparatus, and systems for verifying configuration of networks.

### BACKGROUND OF THE INVENTION

In traditional telecommunications networks, provisioning relates to configuring and administering network nodes that enable service to a customer. Provisioning may encompass a variety of tasks, such as service activation, programming various network databases with the customer's information, and determining configurations for individual network elements. Typically, provisioning involves use of a provisioning system and querying a provisioning database that includes information about the configuration of a network. For example, in asynchronous transfer mode (ATM) networks, provisioning a permanent virtual circuit (PVC) requires querying the provisioning database to determine the current configuration of individual ATM switches supporting the PVC. Based on the configuration information, a technician may then configure each of the ATM switches.

The configuration information entered by a technician is often stored in a network configuration database, which is separate from the provisioning database. Ideally, the network configuration information in both the provisioning database and the network configuration database should be identical.

The network configuration information stored in these databases, however, become inconsistent over time. In networks, especially large networks, the network configuration may change frequently because, for example, the topology of a network may change frequently as nodes are added, removed, modified, and upgraded. The topology may also change when links between nodes are added or removed. In addition, errors may occur when PVCs are added, removed, or modified, as well.

Conventionally, a network administrator must separately track these changes in both the provisioning and network configuration databases and may use software and automated tools to assist in tracking these changes. Unfortunately, tracking these changes is cumbersome, prone to errors, and becomes increasingly difficult as the size of a network increases. Also, even with software and automated tools, frequently the provisioning database and network configuration database may each contain inaccurate information or become inconsistent with each other.

It is therefore desired to provide methods, apparatus, and systems that address the above and other shortcomings of the prior art.

### SUMMARY OF THE INVENTION

Accordingly, methods, apparatus, and systems are provided to verify a configuration of a network. In accordance with one aspect of the present invention, a first set of information relating to a virtual representation of the network and a second set of information relating to a state of the network are provided. Based on the first and second sets of information, it is determined whether the virtual representation and the state of the network are consistent with each other.

In accordance with another aspect of the present invention, a system comprises a first storage storing provisioning information relating to a virtual representation of a network, a second storage storing state information indicating one or more virtual connections traversing the network. Based on the provisioning information and the state information, a processor determines whether the virtual representation and the state of the network are consistent with each other.

In accordance with another aspect of the present invention, information relating to a virtual representation of a virtual connection traversing a network is received. A first identifier for the virtual connection at a first port of a first node within the network and a second identifier for the virtual connection at a second port of a second node within the network are determined. State information from the network relating to respective configurations of the first node and the second node is requested based on the first identifier and the second identifier. Based on the first identifier, the second identifier, and the state information, it is determined whether the virtual representation and the state information are consistent with each other

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

In the Figures:

FIG. 1 illustrates a system, in accordance with methods, apparatus, and systems consistent with the principles of the present invention;

FIG. 2 illustrates a block diagram of a server, in accordance with methods, apparatus, and systems consistent with the present invention;

FIG. 3 illustrates a block diagram of a node in a network, in accordance with methods, apparatus, and systems consistent with the present invention;

FIG. 4 illustrates a cross-connect table in a node, in accordance with methods, apparatus, and systems consistent with the present invention;

FIG. 5 illustrates a provisioning table in a provisioning database, in accordance with methods, apparatus, and systems consistent with the present invention; and

FIG. 6 shows the steps performed by a server for verifying the configuration of a network, in accordance with methods, apparatus, and systems consistent with the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

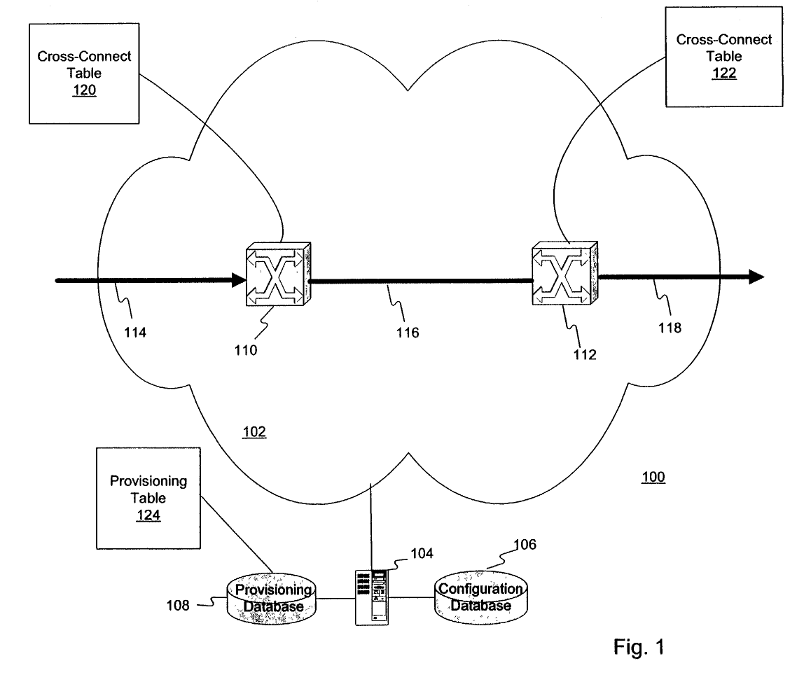

FIG. 1 illustrates a system 100, in accordance with methods, apparatus, and systems consistent with the principles of the present invention. As shown, system 100 comprises a network 102, a server 104, a configuration database 106, and a provisioning database 108.

Network 102 may be implemented as a wide area network (WAN) or a local area network (LAN). Network 102 may be implemented using a variety of technologies alone or in combination, including wireline technologies, such as fiber optic cable, and wireless technologies, such as radio frequency (RF), satellite, and microwave. Furthermore, network 102 may support a variety of protocols including Internet Protocols (IP), Asynchronous Transfer Mode (ATM), Frame-Relay, Ethernet, etc.

Network 102 may include nodes 110 and 112, which serve as points of connection. Although FIG. 1 illustrates two nodes inside network 102, any number of nodes may be interconnected within network 102. Nodes 110 and 112 may each be implemented as a device, such as a switch, a router, a bridge, a hub, a firewall, a computer, etc.

Nodes 110 and 112 may be interconnected by one or more links, where a link may include a path, either physical or logical, that defines a specific communication channel or circuit. A physical link may relate to the electrical and mechanical components embodying the communication channel or circuit. A logical link may include an abstraction of one or more underlying physical links representing the connectivity between two nodes.

For example, as shown in FIG. 1, node 110 may receive data over a link 114 from a node external to network 102 (not shown). Nodes 110 and 112 may be interconnected by a link 116. Node 112 may communicate data over a link 118 to another node external to network 102 (not shown). Nodes 110 and 112 may interconnect any number of links and have links to any number other nodes (not shown) within network 102 based on physical and logical topologies of network 102. A physical topology corresponds to a representation of the physical links in network 102. A logical topology is an abstract representation based on the logical links in network 102.

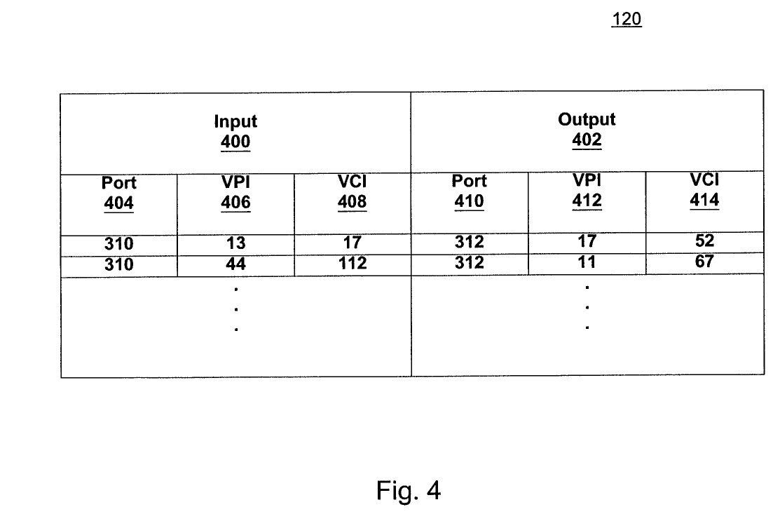

Nodes 110 and 112 may include cross-connect tables 120 and 122, respectively. Cross-connect tables 120 and 122 may store information indicating respective configuration information for virtual connections traversing nodes 110 and 112 in either direction. For example, cross-connect tables 120 and 122 may store information for a virtual connection from node 110 to node 112, or from node 112 to node 110. A virtual connection refers to any type of logical connection traversing a node, such as an IP multiprotocol label switching (“MPLS”) label switched path, an ATM virtual circuit, or a Frame-Relay virtual circuit. For example, cross-connect tables 120 and 122 may indicate the next node to which data for a virtual connection are forwarded. Cross-connect tables 120 and 122 are described below in more detail with reference to FIG. 4. Server 104 may provide operations support for network 102, such as support for configuration management, provisioning, testing, billing, monitoring, and other functions. Server 104 may be implemented as a general-purpose computer using known hardware, such as a processor available from Intel Corporation, and software, such as from Sun Microsystems, Incorporated.

Configuration database 106 may store information relating to the configuration of network 102. For example, configuration database 106 may include information relating to the physical and logical topologies of the network 102. Configuration database 106 may be implemented using known hardware and software, such as an ORACLE database available from Oracle Corporation. Although shown directly connected to server 104, configuration database 106 may be integrated with server 104 or may be remotely connected across a network to server 104.

Provisioning database 108 may store information relating to the provisioning of network 102. Such information may indicate, for example, services provided, transaction logs, requests for services, and updates to provisioning of network 102. Provisioning database 108 may support various types of provisioning, such as circuit provisioning, service provisioning, and switch provisioning. For example, provisioning database 108 may include information about products and services provided over network 102, such as equipment descriptions, wiring information, transmission information, configuration information relating to the physical and logical topologies of network 102, and virtual connections traversing network 102. Provisioning database 108 may include provisioning table 124, which stores information about virtual connections traversing network 102. Provisioning database 108 may be implemented using a combination of known hardware and software. Although shown directly connected to server 104, provisioning database 108 may be integrated with server 104 or may be remotely connected across a network to server 104.

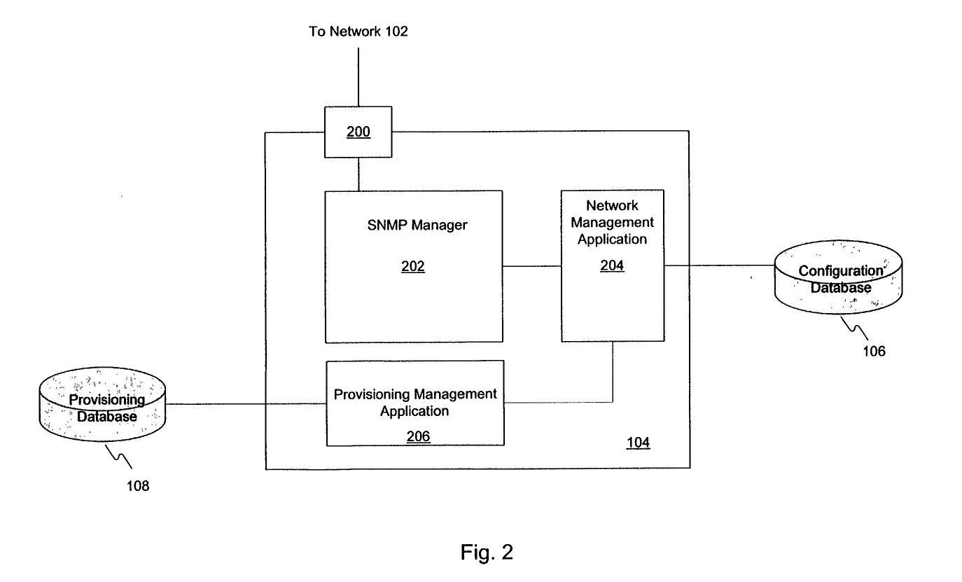

FIG. 2 shows a block diagram of server 104, in accordance with methods, apparatus, and systems consistent with the principles of the present invention. Server 104 may comprise an I/O port 200, a Simple Network Management Protocol (SNMP) manager 202, a network management application 204, and a provisioning management application 206.

I/O port 200 may provide an interface between network 102 and server 104. Although server 104 is shown with one I/O port, any number of ports may be implemented. I/O port 200 may allow server 104 to communicate with nodes 110 and 112. I/O port 200 may be directly connected to nodes 110 and 112, or may be indirectly connected to nodes 110 and 112 via a number of intervening nodes (not shown) within network 102.

SNMP manager 202 may poll and interpret state information received via I/O port 200 from nodes 110 and 112. In one embodiment, SNMP manager 202 may use the SNMP protocol to access state information, such as Management Information Base (“MIB”) parameters from nodes 110 and 112. RFC-1157, J. Case et al., “A Simple Network Management Protocol (SNMP),” (1990), describes, inter alia, the SNMP protocol and MIB parameters and is incorporated herein by reference in its entirety.

For example, SNMP manager 202 may query, get responses, set variables, and acknowledge information to and from nodes 110 and 112 using the following SNMP operations: get( ); get next ( ); get response ( ); set ( ); and trap ( ). SNMP manager 202 may use the “get” or “get next” operations to retrieve state information from nodes 110 and 112, such as information from cross-connect tables 120 and 122, within one or more SNMP messages. SNMP manager 202 may use the “get response” operation to respond to a “get” operation. SNMP manager 202 may use the “set” operation to alter a variable or MIB parameter in nodes 110 and 112. The “trap” operation allows nodes 110 and 112 to report an SNMP event to SNMP manager 202 in response to an alarm condition.

Alternatively, SNMP manager 202 may use other network management schemes alone or in combination with SNMP. For example, SNMP manager 202 may use IP utilities, such as pings, traceroutes, and zone transfers. In addition, SNMP manager 202 may use ATM operations and maintenance (“OAM”) cells or communications languages, such as Transaction Language 1 (“TL1”). Furthermore, proprietary schemes from particular manufacturers may also be incorporated into SNMP manager 202.

Network management application 204 may interface configuration database 106 to provide analysis functions to determine a state of network 102 based on state information, such as MIB parameters received by SNMP manager 202 from nodes 110 and 112. Functions supported by network management application 204 may include one or more of the following: providing information about topologies of network 102; providing a user interface to interact with nodes 110 and 112; providing various displays indicating the status of nodes 110 and 112; and a compiling function used in conjunction with configuration database 106 to store and access MIB parameters. Network management application 204 may be implemented using known software, such as the NETVIEW product family provided by the International Business Machines (“IBM”) Corporation, or the OPENVIEW product family from the Hewlett Packard (“HP”) Company. Although FIG. 2 shows one network management application, one skilled in the art would understand that multiple network management applications and SNMP managers may be implemented in a single server or across multiple servers coupled together.

Provisioning management application 206 may interface provisioning database 108 to provide a virtual representation of at least a portion of network 102 based on provisioning information stored in provisioning table 124. Provisioning management application 206 may also provide a user interface for accessing, querying, and modifying provisioning information in provisioning database 108. Functions supported by provisioning management application 206 may include one or more of the following: providing provisioned topologies (both physical and logical) for network 102; determining provisioning information for nodes 110 and 112; determining services provided over network 102; logging transactions related to network 102, such as topology changes; and modifying provisioning information. Although FIG. 2 shows one provisioning management application within server 104, one skilled in the art would understand that multiple provisioning management applications and provisioning databases may be implemented in a single server or across multiple servers coupled together.

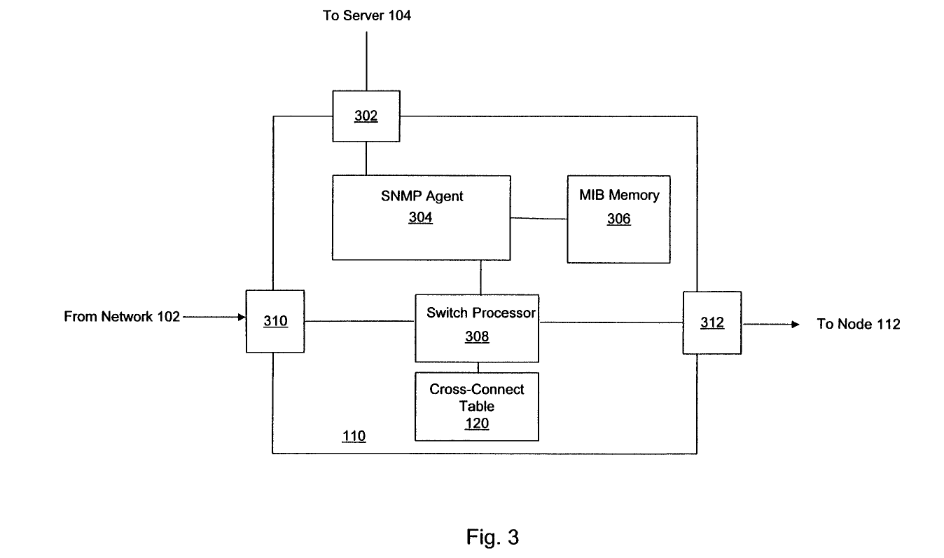

FIG. 3 illustrates a block diagram of node 110, in accordance with methods, apparatus, and systems consistent with the present invention. As shown, node 110 may comprise a management port 302, an SNMP agent 304, a MIB memory 306, a switch processor 308, a port 310, a port 312, and cross-connect table 120.

Node 110 may use management port 302 to send and receive state information, such as MIB parameters within one or more SNMP protocol messages. For example, node 110 may use management port 302 to provide state information to server 104 via I/O port 200. Although node 110 is shown with one management port, any number of management ports may be implemented. Alternatively, node 110 may send and receive state information using other ports, such as port 310 or port 312.

SNMP agent 304 may maintain and provide state information for node 110. For example, SNMP agent 304 may retrieve and store MIB parameters in MIB memory 306, respond to queries from SNMP manager 202, and provide information in response to an event, such as an alarm condition.

SNMP agent 304 may also allow node 110 to act as a proxy for another node, such as node 112. When acting as a proxy, node 110 may use non-SNMP communications, such as proprietary messages to communicate with node 112. Upon receiving the state information from node 112, node 110 may then translate and forward this state information in the form of SNMP messages. Alternatively, node 112 may also include its own SNMP agent and communicate directly with server 104.

MIB memory 306 may store state information, such as MIB parameters collected by SNMP agent 304. MIB memory 306 may store state information, such as address information for virtual connections traversing node 110, information from cross-connect table 120, error counts, and on/off status information. MIB memory 306 may also store other types of state information, such as traffic statistics for node 110.

Switch processor 308 may examine and forward data relating to one or more virtual connections traversing node 110. For example, for an ATM virtual connection, switch processor 308 may receive an incoming ATM cell via port 310 and determine a VPI and VCI from the header of the ATM cell. Switch processor 308 may then refer to cross-connect table 120 based on the port from which the ATM cell was received and the determined VPI and VCI. Switch processor 308 may then determine a port to output the ATM cell, such as port 312, assign an output VPI and VCI to the ATM cell, and forward the ATM cell to node 112.

FIG. 4 illustrates cross-connect table 120 in node 110, in accordance with methods, apparatus, and systems consistent with the present invention. As shown, cross-connect table 120 may include an input section 400 and an output section 402. In one embodiment, input section 400 may include a port column 404, a VPI column 406, and a VCI column 408.

Port column 404 may identify a port from which data for a virtual connection is received. VPI column 406 and VCI column 408 may identify the respective VPI and VCI of an incoming ATM cell. In order to forward the incoming ATM cell, information in port column 404, VPI column 406, and VCI column 408 may then be mapped to information in output section 402.

Output section 402 may include a port column 410, a VPI column 412, and a VCI column 414. Port column 410 may indicate a port to which the ATM cell will be forwarded. VPI column 412 and VCI column 414 may indicate the respective VPI and VCI assigned to the incoming ATM cell and used to create an outgoing ATM cell.

For example, as shown in FIG. 4, an incoming ATM cell for a virtual connection from node 110 to node 112 may be received via port 310 with a VPI/VCI of 13/17. Based on cross-connect table 120, node 110 may map this incoming cell to port 312 and assign a new VPI/VCI of 17/52 when creating an outgoing ATM cell from the incoming ATM cell. Node 110 may then forward the outgoing ATM cell to node 112. As another example, an incoming ATM cell for a virtual connection from node 110 to node 112 may be received via port 310 with a VPI/VCI of 44/112 and may be mapped to port 312. This incoming ATM cell may then be assigned a new VPI/VCI of 11/67 by node 110 when creating the outgoing ATM cell. Node 110 may then forward the outgoing ATM cell to node 112. Although cross-connect table 120 is described with reference to ATM virtual connections, cross-connect table 120 may include information for other types of virtual connections, such as frame-relay virtual circuits or MPLS label switched paths.

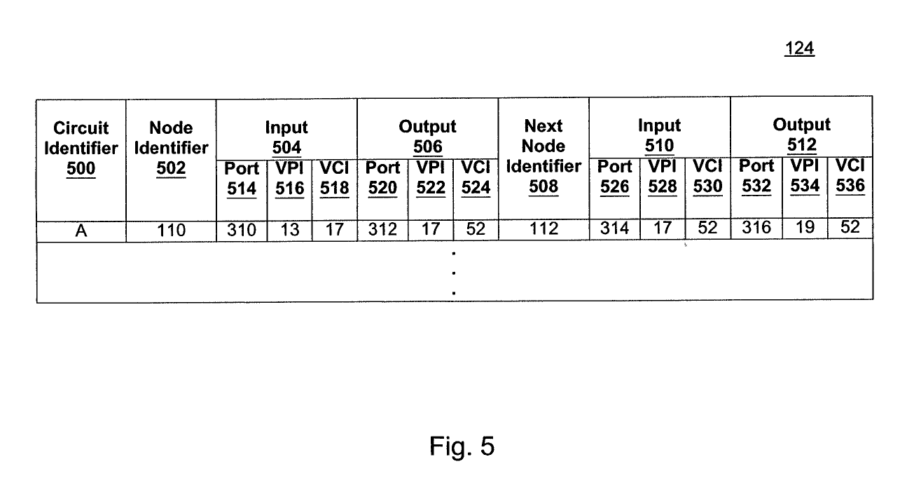

FIG. 5 illustrates provisioning table 124 in provisioning database 108, in accordance with methods, apparatus, and systems consistent with the present invention. As shown, provisioning table 124 may include a circuit identifier column 500, a node identifier column 502, an input section 504, an output section 506, a next node identifier column 508, an input section 510, and an output section 512.

Circuit identifier column 500 may identify a virtual connection, such as an ATM virtual connection provisioned across network 102. Circuit identifier column 500 may also include other information, such as a customer identifier, a source identifier, a destination identifier, etc.

Node identifier column 502 may identify a particular node across which a virtual connection is provisioned. Input section 504 and output section 506 each may correspond to cross-connect information for the node identified in node identifier column 502. In one embodiment, input section 504 and output section 506 each may include cross-connect information for an ATM virtual connection. For example, input section 504 may include a port column 514, a VPI column 516, and a VCI column 518. In addition, output section 506 may include a port column 520, a VPI column 522, and a VCI column 524.

Next node identifier column 508 may identify the next node provisioned to receive data for a virtual connection from the node identified in node identifier column 502. Input section 510 and output section 512 each may correspond to cross-connect information for the node identified in next node identifier column 508. In one embodiment, input section 510 and output section 512 each may include cross-connect information for an ATM virtual connection. For example, input section 510 may include a port column 526, a VPI column 528, and a VCI column 530. In addition, output section 512 may include a port column 532, a VPI column 534, and a VCI column 536.

For example, as shown in FIG. 5, an ATM virtual connection may be identified with a circuit identifier “A” and one direction of the ATM virtual connection may be provisioned from node 110 to node 112. At node 110, incoming ATM cells for virtual connection “A” may be received at port 310 and have a VPI/VCI of 13/17. Outgoing cells for virtual connection “A” may then be forwarded to port 312 and assigned a new VPI/VCI of 17/52. The outgoing cell from node 110 may then be received at node 112 as an incoming ATM cell at a port 314. The incoming ATM cell may then be forwarded to a port 316 and assigned a new VPI/VCI of 19/52. Although provisioning table 124 is described with reference to one direction of an ATM virtual connection, provisioning table 124 may include information for other directions of a virtual connection and may also include information for other types of virtual connections, such as frame-relay virtual circuits or MPLS label switched paths.

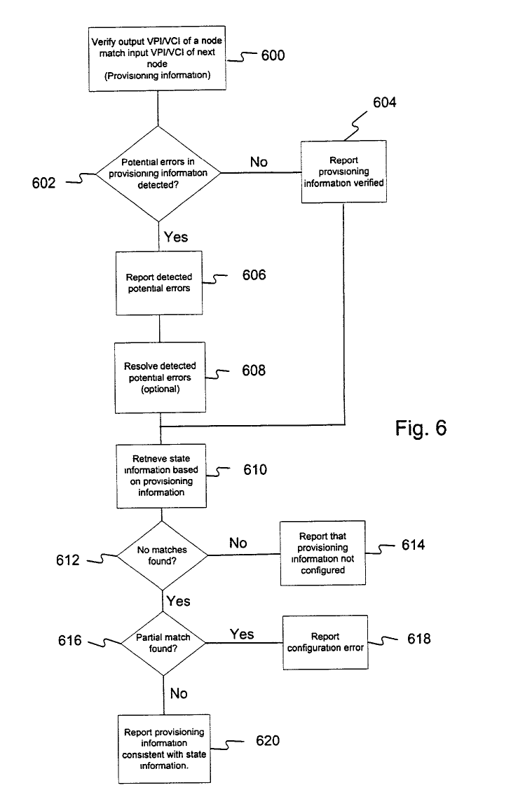

FIG. 6 shows the steps performed by server 104 for verifying the configuration of network 102, in accordance with methods, apparatus, and systems consistent with the present invention. Server 104 may verify the configuration of network 102 upon request, such as in response to a customer complaint or a request to verify a newly provisioned virtual connection. Server 104 may also conduct bulk verification of virtual connections traversing network 102.

In stage 600, server 104 may verify that provisioning information indicating the output VPI/VCI assigned by a node is the same as the input VPI/VCI used by the next node for a virtual connection. For example, server 104 may refer to provisioning table 124 to verify that the VPI/VCI in columns 522 and 524 assigned by node 110 are consistent with the VPI/VCI in columns 528 and 530 for the input of node 112.

In stage 602, server 104 may determine if one or more potential errors exist in provisioning table 124. For example, if the VPI/VCI in columns 522 and 524 assigned by node 110 do not match the VPI/VCI in columns 528 and 530 for the input of node 112, then server 104 may determine that those particular VPI or VCI entries for node 112 are inconsistent and may identify them as potential errors.

In stage 604, if server 104 does not detect any potential errors, then server 104 may report that the virtual representation of network 102 is verified based on the provisioning information. Processing may then flow to stage 610.

In stage 606, if server 104 detects one or more potential errors, then server 104 may report the errors including the particular VPI or VCI entries related to the errors. For example, server 104 may use the user interface function of provisioning management application 206 to report the errors.

In stage 608, for each of the errors detected (if any), server 104 may resolve the errors based on state information retrieved from nodes 110 and 112. For example, server 104 may refer to provisioning table 124 and retrieve information from node identifier column 502 and next node identifier column 508 to determine which nodes in network 102 to query. Server 104 may then direct SNMP manager 202 to use one or more get( ) or get next( ) operations to request information from nodes 110 and 112. Nodes 110 and 112 may then provide the requested information from information in at least a portion of cross-connect tables 120 and 122, respectively, based on the request from server 104. Alternatively, server 104 may use network management application 204 to query configuration database 106 based on information from provisioning table 124.

To resolve the potential errors in provisioning table 124, server 104 may then compare the information from cross-connect tables 120 and 122 with information in provisioning table 124. For example, if the information in provisioning table 124 corresponding to the potential errors is inconsistent with information in cross-connect tables 120 and 122, then server 104 may declare that the detected errors in provisioning table 124 are confirmed errors. Server 104 may then report suggested changes to provisioning table 124 to match the information in cross-connect tables 120 and 122. For example, server 104 may use provisioning management application 206 to report the suggested changes to the user. Alternatively, server 104 may proceed without resolving all of the detected errors.

In stage 610, server 104 may retrieve state information from nodes 110 and 112 based on information in provisioning table 124. For example, server 104 may read information from provisioning table 124, such as entries from node identifier column 502, input section 504, and output section 506 and use SNMP manager 202 to send get( ) or get next( ) operations to request state information from node 110 identified in node identifier column 502. Node 110 may reply to the request and server 104 may examine the reply. For example, node 110 may provide to server 104, via a get response( ) message, information from cross-connect table 120, such as input section 400 and output section 402. Server 104 may then use network management application 204 to examine the reply and determine its contents.

In stage 612, server 104 may determine whether node 110 sent a “NULL” reply indicating that no information was found in cross-connect table 120 that matches the information from provisioning table 124.

In stage 614, if server 104 received a “NULL” reply, then server 104 may report that the virtual connection has not been configured in node 110. For example, server 104 may use provisioning management application 206 to report that node 110 has not been configured and provide information from provisioning table 124.

In stage 616, server 104 may determine whether node 110 replied with information from cross-connect table 120 that only partially matches the information from provisioning table 124. In stage 618, if server 104 received only partially matching information from node 110, then server 104 may report that cross-connect table 120 and provisioning table 124 are inconsistent with each other and that node 110 was incorrectly configured. For example, information from input section 400 of cross-connect table 120 may match information from input section 504 of provisioning table 124. However, information from output section 402 of cross-connect table 120 may not match information from output section 506. Server 104 may also provide suggested changes to the configuration of node 110 based on the information from provisioning table 124.

In stage 620, since no partial matches were found, server 104 may then report that the provisioning information from provisioning table 124 is consistent with the state information from cross-connect table 120. For example, server 104 may use provisioning management application 206 to report that the provisioning information in provisioning database 108 is consistent with the state information from network 102.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for verifying a configuration of a network, the method comprising:
receiving a first set of information relating to a virtual representation of the network;
receiving a second set of information relating to a state of the network; and
determining, based on the first set and second set of information, whether the virtual representation and the state of the network are consistent with each other.

2. The method of claim 1, wherein receiving the first set of information comprises:
receiving information about provisioning of the network.

3. The method of claim 2, wherein receiving information about provisioning of the network comprises:
receiving information about a virtual connection in the network.

4. The method of claim 3, wherein receiving information about the virtual connection in the network, comprises:
receiving a virtual path identifier for the virtual connection at a node in the network.

5. The method of claim 3, wherein receiving information about the virtual connection in the network, comprises:
receiving a virtual channel identifier for the virtual connection at a node in the network.

6. The method of claim 1, wherein receiving the second set of information comprises:
retrieving management information base parameters from one or more nodes in at least a portion of the network.

7. The method of claim 6, wherein determining whether the virtual representation and the state of the network are consistent comprises:
identifying, based on the retrieved management information base parameters, one or more respective virtual connections traversing the one or more nodes; and
comparing at least a portion of the virtual representation with the retrieved management information base parameters.

8. An apparatus, comprising:
means for receiving a first set of information relating to a virtual representation of a network;
means for receiving a second set of information relating to a state of the network; and
means for determining, based on the first and second sets of information, whether the virtual representation and the state of the network are consistent with each other.

9. The apparatus of claim 8, wherein the means for receiving the first set of information comprises:
means for receiving information about provisioning of the network.

10. The apparatus of claim 9, wherein the means for receiving information about provisioning of the network comprises:
means for receiving information about a virtual connection in the network.

11. The apparatus of claim 8, wherein the means for receiving the second set of information comprises:
means for retrieving management information base parameters from one or more nodes in at least a portion of the network.

12. A system, comprising:
a first storage that stores provisioning information relating to a virtual representation of a network;
a second storage that stores state information indicating one or more virtual connections traversing the network; and
a processor that determines whether the virtual representation and a state of the network are consistent with each other based on the provisioning information and the state information.

13. The system of claim 12, wherein the provisioning information indicates that the one or more virtual connection traverse a first node and a second node in the network.

14. The system of claim 13, wherein the state information indicates respective configurations of the first node and the second node.

15. The system of claim 14, wherein the state information comprises management information base parameters from the first node and the second node.

16. The system of claim 15, wherein the management information base parameters indicate a first identifier at a first port of the first node and a second identifier at a second port of the second node for at least one of the one or more virtual connections.

17. The system of claim 14, wherein the processor determines respective identifiers for the one or more virtual connections at the first node and the second node based on the provisioning information.

18. The system of claim 17, wherein the processor determines whether the virtual representation and the state of the network are consistent with each other based on the respective identifiers for the one or more virtual connections at the first and second nodes and the respective configurations of the first and second nodes.

19. A method, comprising:
receiving information relating to a virtual representation of a virtual connection traversing a network;
determining a first identifier for the virtual connection at a first port of a first node in the network;
determining a second identifier for the virtual connection at a second port of a second node in the network;
receiving state information from the network relating to respective configurations of the first node and the second node based on the first identifier and the second identifier; and
determining whether the virtual representation and the state information are consistent with each other based on the first identifier, the second identifier, and the state information.

20. The method of claim 19, wherein receiving state information from the network comprises receiving management information base parameters from the first node and the second node.
